(19) United States
(12) Patent Application Publication
(10) Pub. No.: US 2018/0175575 A1
(43) Pub. Date: Jun. 21, 2018

(54) TOOL HEADS AND TOOL SYSTEMS

(71) Applicant: Ridge Tool Company, Elyria, OH (US)

(72) Inventors: Brendon Goede, Avon, OH (US); Rahul Maruti Nanche, Maharashtra (IN); Harald Krondorfer, Aurora, OH (US); Matthew Bertram, Medina, OH (US)

(21) Appl. No.: 15/439,067

(22) Filed: Feb. 22, 2017

(30) Foreign Application Priority Data
Dec. 16, 2016 (IN) 201621042924

(51) Int. Cl. H01R 43/058; B23P 11/00; H01R 43/048

(52) U.S. Cl. CPC H01R 43/058; H01R 43/048; B23P 11/005

(57) ABSTRACT

Tool heads for use with a powered actuator are described. The tool heads are configured for pressing or crimping fittings and particularly electrical connectors. Generally, the tool head includes a frame, a roller carriage, and a pair of pivotally attached jaws that are biased to an open position. The tool head may in certain versions, include provisions that enable the tool head to be releasably engaged with a powered actuator such as a hydraulic actuator. Also described are tool systems using the various tool heads.

### FIELD

The present subject matter relates to tool heads for use in pressing or crimping operations such as in crimping electrical connectors. The present subject matter also relates to tool systems using the various tool heads.

### BACKGROUND

Electrical contractors use crimpable connectors to form terminations on various copper and aluminum wires. Examples of such connectors are described in UL Standard 486 provided by Underwriters Laboratories, Inc. A variety of crimping tools and crimp profile die geometries are used to crimp connectors. However, electrical utility companies typically use micro hydraulic tools and a range of crimp jaws having a single pivot design.

Many tools utilize a hydraulic actuator and a removable crimp head that includes a pair of jaws. Upon operation of the actuator, a hydraulic ram urges rollers into contact with cam surfaces provided on the jaws to close the jaws. The typical jaw design is biased open using an extension spring located near the cam surfaces of the jaws. Some jaw designs also have projections on the outer part of the jaw that limit the extent of jaw opening. Such designs prevent the cam surfaces from contacting the rollers in the starting position. In addition, some of the jaws do not remain assembled when removed from the tool. That is, the jaws must be assembled with the tool before use. Other jaw designs use a “sleeve” that is placed along the jaw pivot location. The sleeve allows the jaw set to be removed from the tool as a complete assembly. By removing the pivot pin from the tool, the jaws can be replaced with jaws having different sized profiles to allow a multitude of fittings to be crimped.

Although satisfactory in certain regards, a need remains for an improved tool head and related tool system.

### SUMMARY

The difficulties and drawbacks associated with previous approaches are addressed in the present subject matter as follows.

In one aspect, the present subject matter provides a tool head comprising a pair of pivotally attached jaws. Each jaw defines a forward end, a rearward end, and a work surface. Each jaw further defines a cam surface proximate the rearward end. The jaws are positionable between a fully opened position and a fully closed position. The tool head also comprises a roller carriage positionable between a fully extended position and a fully retracted position. The roller carriage includes rollers positioned to contact the cam surface of each jaw upon positioning the roller carriage toward the fully extended position, thereby resulting in the jaws being positioned to the closed position. The tool head also comprises a frame defining a forward end and a rearward end. The frame supports and at least partially encloses the pair of jaws and the roller carriage. The tool head also comprises provisions for enabling the frame and the pair of jaws to be releasably engageable with a powered actuator. And, the tool head also comprises a biasing member that urges (i) the pair of jaws to the fully opened position, and (ii) the roller carriage to the fully retracted position.

In another aspect, the present subject matter provides a tool head comprising a pair of pivotally attached jaws. Each jaw defines a forward end, a rearward end, and a work surface. Each jaw further defines a cam surface proximate the rearward end. The jaws are positionable between a fully opened position and a fully closed position. The tool head also comprises a roller carriage positionable between a fully extended position and a fully retracted position. The roller carriage includes rollers positioned to contact the cam surface of each jaw upon positioning the roller carriage toward the fully extended position, thereby resulting in the jaws being positioned to the closed position. The tool head also comprises a frame defining a forward end and a rearward end. The frame supports the roller carriage and the pair of jaws. The tool head defines a longitudinal axis, wherein upon positioning the pair of jaws to the fully closed position, each cam surface defined on a jaw extends from the rearward end of the respective jaw toward the longitudinal axis at an angle of from 40° to 50° as measured from the longitudinal axis.

In yet another aspect, the present subject matter provides a tool system comprising a powered actuator, and a tool head. The tool head includes a pair of pivotally attached jaws. Each jaw defines a forward end, a rearward end, and a work surface. Each jaw further defines a cam surface proximate the rearward end. The jaws are positionable between a fully opened position and a fully closed position. The tool head also includes a roller carriage positionable between a fully extended position and a fully retracted position. The roller carriage includes rollers positioned to contact the cam surface of each jaw upon positioning the roller carriage toward the fully extended position, thereby resulting in the jaws being positioned to the closed position. The tool head additionally includes a frame defining a forward end and a rearward end. The frame supports and at least partially enclosing the pair of jaws and the roller carriage. The tool head further includes provisions for enabling the frame and the pair of jaws to be releasably engageable with the powered actuator. The tool head also includes a biasing member that urges (i) the pair of jaws to the fully opened position, and (ii) the roller carriage to the fully retracted position.

In still another aspect, the present subject matter provides a tool system comprising a powered actuator, and a tool head. The tool head includes a pair of pivotally attached jaws. Each jaw defines a forward end, a rearward end, and a work surface. Each jaw further defines a cam surface proximate the rearward end. The jaws are positionable between a fully opened position and a fully closed position. The tool head also includes a roller carriage positionable between a fully extended position and a fully retracted position. The roller carriage includes rollers positioned to contact the cam surface of each jaw upon positioning the roller carriage toward the fully extended position, thereby resulting in the jaws being positioned to the closed position. The tool head additionally includes a frame defining a forward end and a rearward end. The frame supports the roller carriage and the pair of jaws. The tool head defines a longitudinal axis, wherein upon positioning the pair of jaws to the fully closed position, each cam surface defined on a jaw extends from the rearward end of the respective jaw toward the longitudinal axis at an angle of from 40° to 50° as measured from the longitudinal axis.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a rear perspective view illustrating an embodiment of a tool head in accordance with the present subject matter.

FIG. 2 is a side view of the tool head.

FIG. 3 is a front perspective view of the tool head in a partially disassembled state.

FIG. 4 is a side view of the tool head showing the jaws in a fully opened position.

FIG. 5 is a top view of the tool head.

FIG. 6 is a front end view of the tool head.

FIG. 7 is a cross sectional view of the tool head shown in FIG. 4 in which the jaws are in a fully opened position, the cross section taken along plane A-A in FIG. 6.

FIG. 8 is a cross sectional view of the tool head shown in which the jaws are in a closed position, the cross section taken along plane A-A in FIG. 6.

FIG. 9 illustrates a first side of one of the jaws of the tool head.

FIG. 10 illustrates a top view of the jaw of FIG. 9.

FIG. 11 illustrates a second side of the jaw depicted in FIG. 9.

### DETAILED DESCRIPTION OF THE EMBODIMENTS

The present subject matter provides a tool head that comprises a pair of jaws that are urged close to perform a pressing or crimping operation. The jaw set is incorporated in a frame that in many embodiments includes provisions enabling the tool head to be releasably engaged with an actuator such as a hydraulic actuator. In particular embodiments, the releasable engagement provisions are in the form of a “Quick Change System™” or QCS system used in conjunction with many actuators available from the Ridge Tool Company such as RE6 and RE60 actuators. Instead of coupling the actuator to the jaws at a pivot pin as is conventional, the actuator is coupled with a QCS collar of the tool head. Thus, a roller assembly and a frame that holds the jaw pivot pin are integral with the jaw assembly. A torsion spring is located around the jaw pivot pin and between portions of the jaws. The spring biases the jaws to an open position at the starting position. A detent is located on each jaw to accept various crimp dies.

In many embodiments, the tool heads of the present subject matter include several key features that further differentiate the tool heads and jaw sets from conventional jaws. First, the tool head is an integrated assembly that in many embodiments uses the QCS system. This allows the jaws to be quickly removed and replaced with other tool heads without assembling the jaws first.

Additionally, the cam angle of the jaws is much steeper than previously known jaw sets. At present, hydraulic tools used in the field by utility companies are intended for specific crimping and cutting applications. Therefore, such tools typically produce 15-20 kN of linear force for that limited set of applications. In contrast, the RE6 and RE60 actuators are used for a variety of applications requiring up to 60 kN of force, i.e., steel panel knockout punching. As a result, the cam angle used in the jaws of the present subject matter tool head is significantly greater than that found in conventional jaw sets in the field so that the present jaws deliver the appropriate level of force at the crimp profile of the jaw.

Another consequence of this relatively large cam angle is that a torsion spring can be used at the pivot location of the jaws to bias the jaws open and retract the roller carriage. Although many conventional jaws use a spring to bias the jaws to an open or closed position, the cam angle used in the jaws of the present tool head has a sufficient mechanical advantage to also bias the roller carriage in addition to the jaw set. Typically, a separate compression spring is used to bias a roller carriage to a fully extracted or retracted position. Thus the present subject matter tool heads eliminate or reduce the number of biasing members that would otherwise be required.

Another feature relates to the provision of a flexible cover that fits over the jaw set to protect the user from pinch points, and protect the assembly from foreign debris. This is not found on other jaw designs.

Generally, the present subject matter tool heads comprise a pair of pivotally attached jaws, a roller carriage, and a frame. The frame supports and at least partially encloses the pair of jaws and the roller carriage. The jaws are positionable between a fully opened position and a fully closed position. The roller carriage is typically disposed at least partially within the frame and is positionable between a fully extended position and a fully retracted position. The roller carriage includes rollers that are positioned to contact corresponding cam surfaces defined on the jaws. In many embodiments, the tool heads also comprise one or more biasing members. The biasing member(s) urge the pair of jaws to the fully opened position, and/or urge the roller carriage to the fully retracted position. As noted, in many embodiments a single biasing member is used to bias both sets of components, i.e., the pair of jaws and the roller carriage. And, in many embodiments, the tool heads comprise releasable engagement provisions that enable the frame and the pair of jaws to be releasably engaged with a powered actuator. Additional details of the embodiments of the tool heads are provided in association with the accompanying figures as follows.

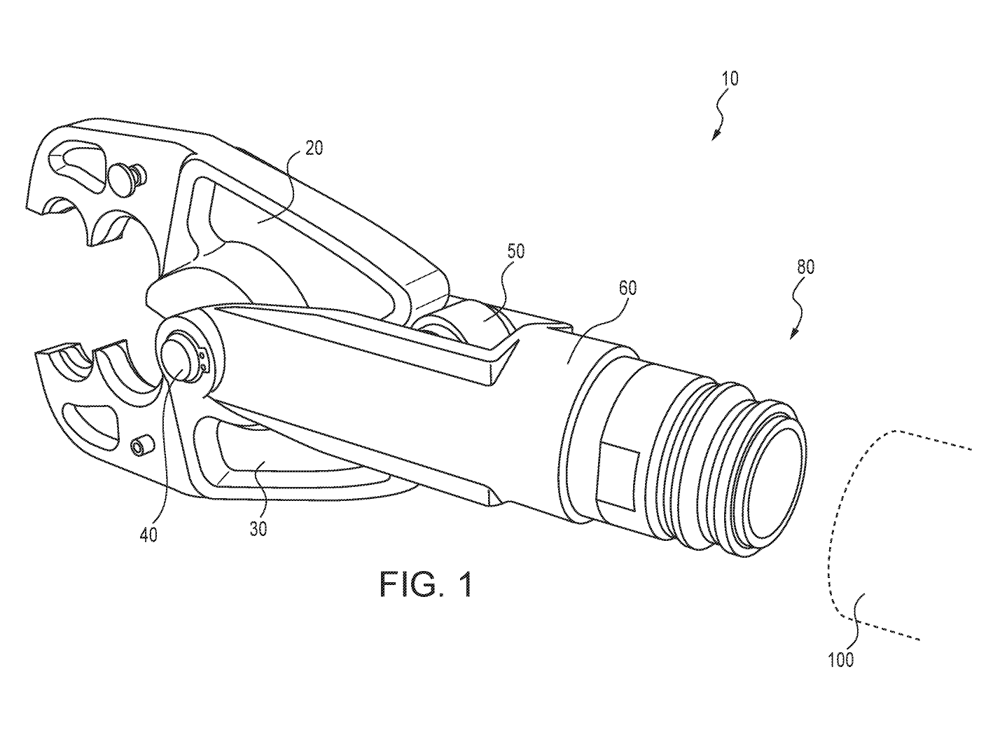

FIG. 1 illustrates a tool head 10 in accordance with the present subject matter. The tool head 10 comprises a first jaw 20 and a second jaw 30 pivotally attached to each other via a pivot assembly 40. The tool head 10 also comprises a roller carriage 50 movably disposed within a frame 60. The frame includes releasable engagement provisions 80 which may be in the form of a Quick Connect System as previously described. The releasable engagement provisions 80 are configured for releasable engagement with an actuator 100.

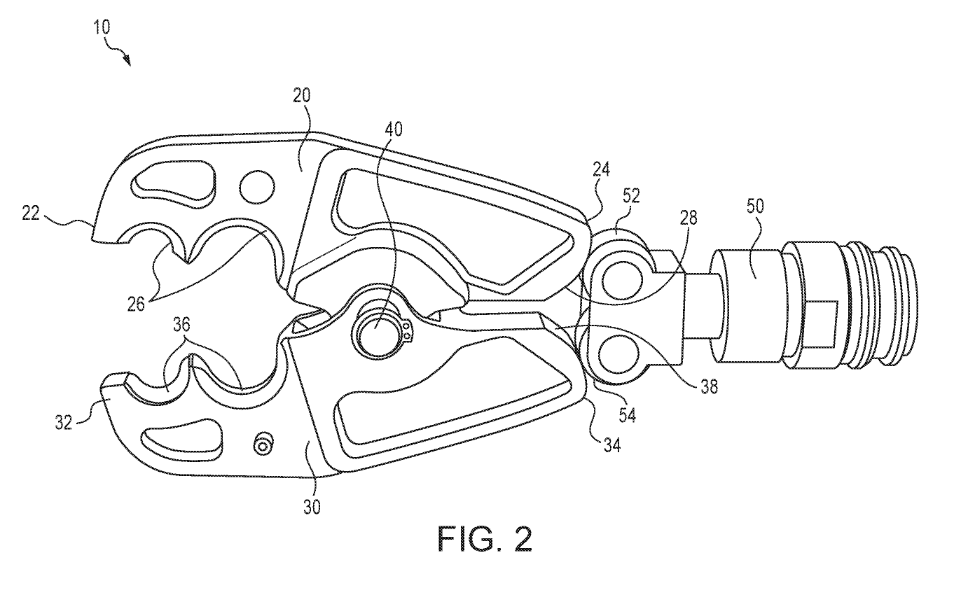

FIG. 2 illustrates the tool head 10 without the frame 60 to show additional aspects of the subject matter. The first jaw 20 defines a forward end 22 and an opposite rearward end 24. Similarly, the second jaw 30 defines a forward end 32 and an opposite rearward end 34. Each jaw defines one or more work surface(s) at which crimping or pressing of components occur. Thus, the first jaw 20 defines a work surface 26 and the second jaw 30 defines a work surface 36. Each jaw also defines a cam surface along which a roller of the roller carriage 50 contacts. Specifically, the first jaw 20 defines a cam surface 28 for contact with a roller 52 of the roller carriage 50. And, the second jaw 30 defines a cam surface 38 for contact with a roller 54 of the roller carriage 50.

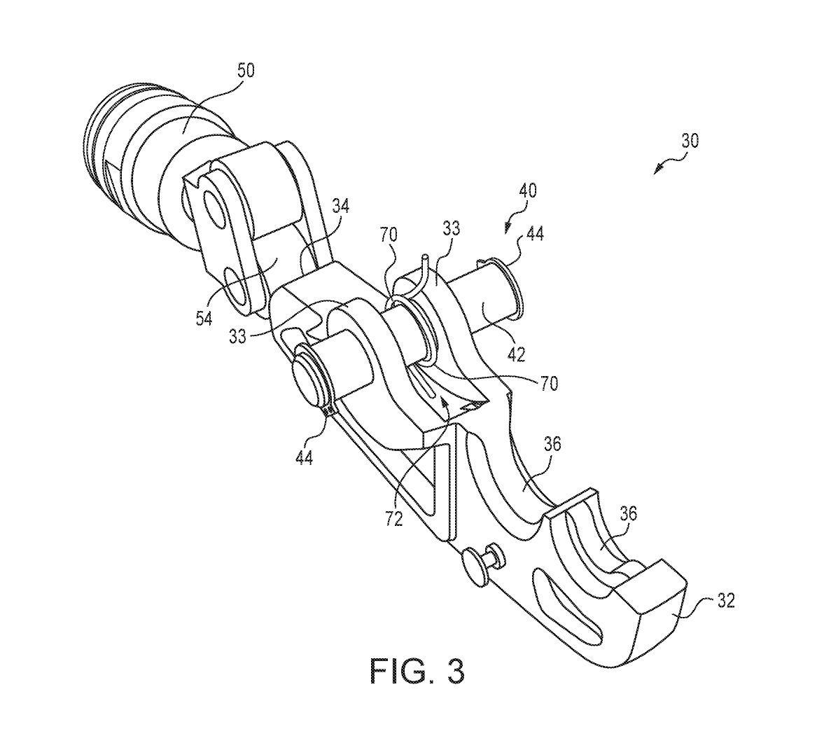

FIG. 3 illustrates additional features and aspects of the jaws, by reference to the second jaw 30. Each jaw such as for example the second jaw 30 includes one or more work surfaces 36 extending between the forward end of the jaw 22 and the pivot assembly 40. Each jaw includes one or more jaw ears 33. The pivot assembly 40 includes a pin 42 which extends through apertures defined in the jaw ears 33. The pivot assembly 40 may additionally include one or more retaining members such as retaining washers 44 for retaining the pin 42 in aligned apertures of the jaws 20, 30. The tool head 10 also comprises a biasing member 70. In the particular embodiment depicted in the noted figures, the second jaw 30 includes two ears 33 spaced apart from one another to thereby define a cavity 72 between the ears 33. The biasing member 70 is disposed at least partially within the cavity 72. As previously noted, in many embodiments, the biasing member 70 is in the form of a torsion spring.

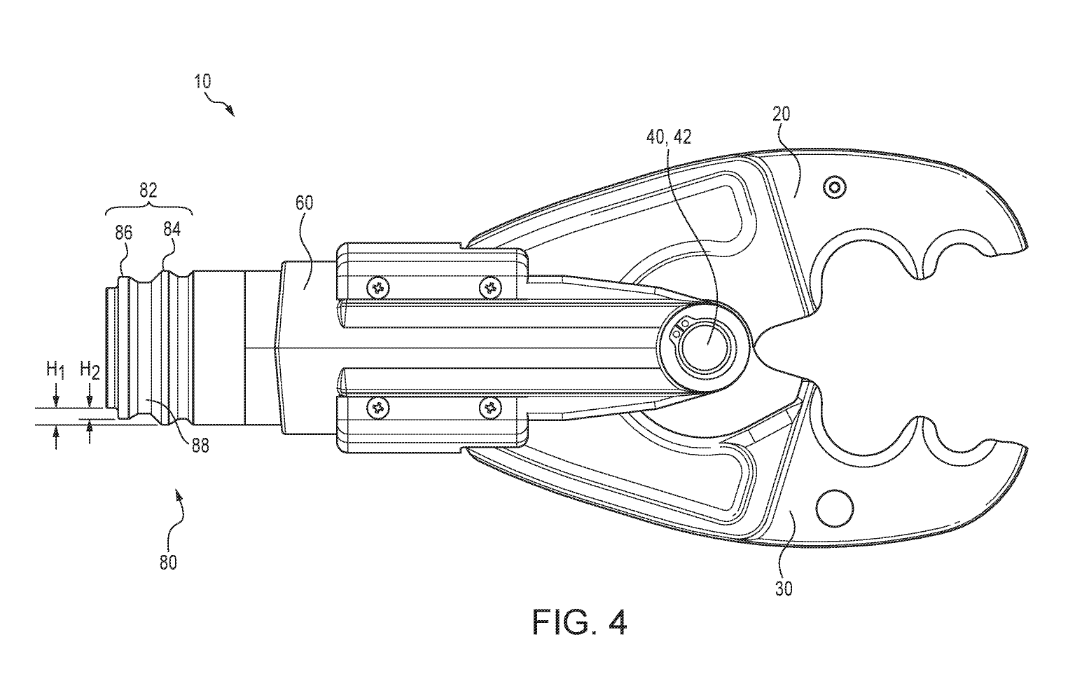

FIG. 4 illustrates the tool head 10 having its jaws 20, 30 in a fully opened position. FIG. 4 also depicts additional features of the Quick Connect System 80. Specifically, the Quick Connect System includes a QCS collar 82 having a first circumferential ridge 84, a second circumferential ridge 86, and a circumferential recess 88 located between the ridges 84 and 86. The second ridge 86 is located closer to an end of the tool head at which an actuator connects, than is the first ridge 84. The height of the second ridge 86, i.e., H₂, is less than that of the first ridge 84, i.e., H₁.

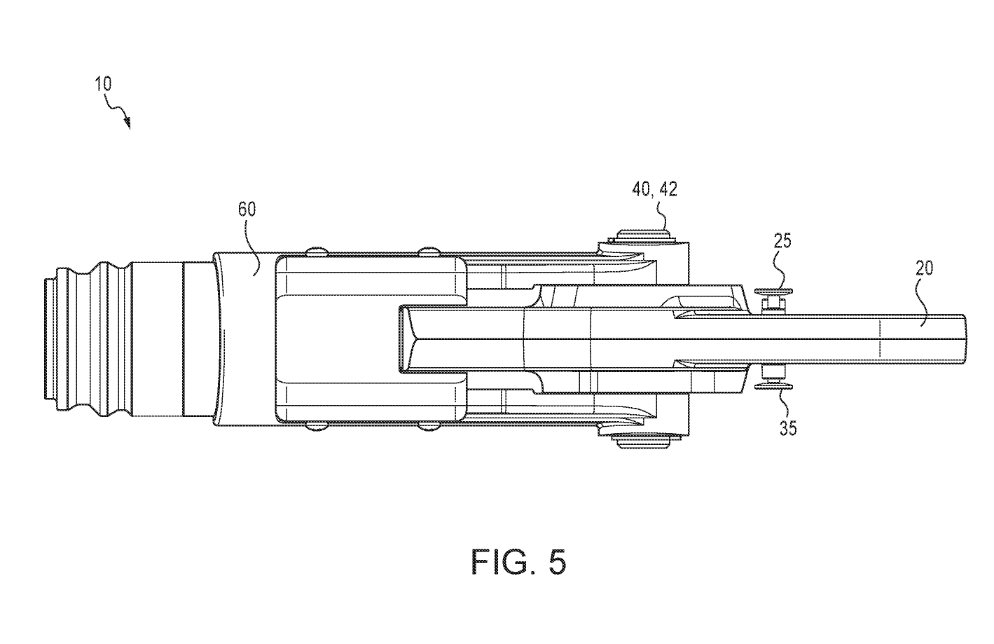

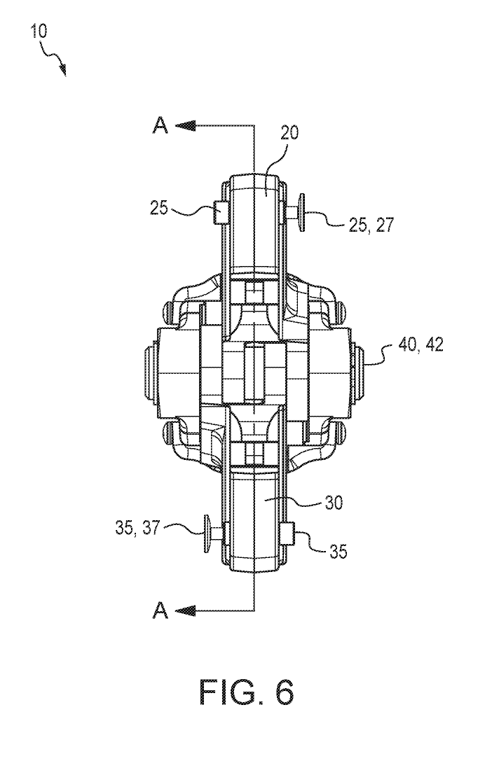

FIGS. 5 and 6 illustrate additional features and aspects of the tool head 10. For example, one or both of the jaws 20, 30 can include one or more detents such as detent 25 of the first jaw 20 and/or the detent 35 of the second jaw 30. The detents serve to releasably retain dies or other members to the jaws and particularly while the die or member is disposed along a work surface of a jaw. In a particular embodiment, each detent includes a detent head 27, 37 and the detents 25, 35 are located on the jaws such that the detent heads are disposed on opposite sides of a respective jaw as best shown in FIG. 6.

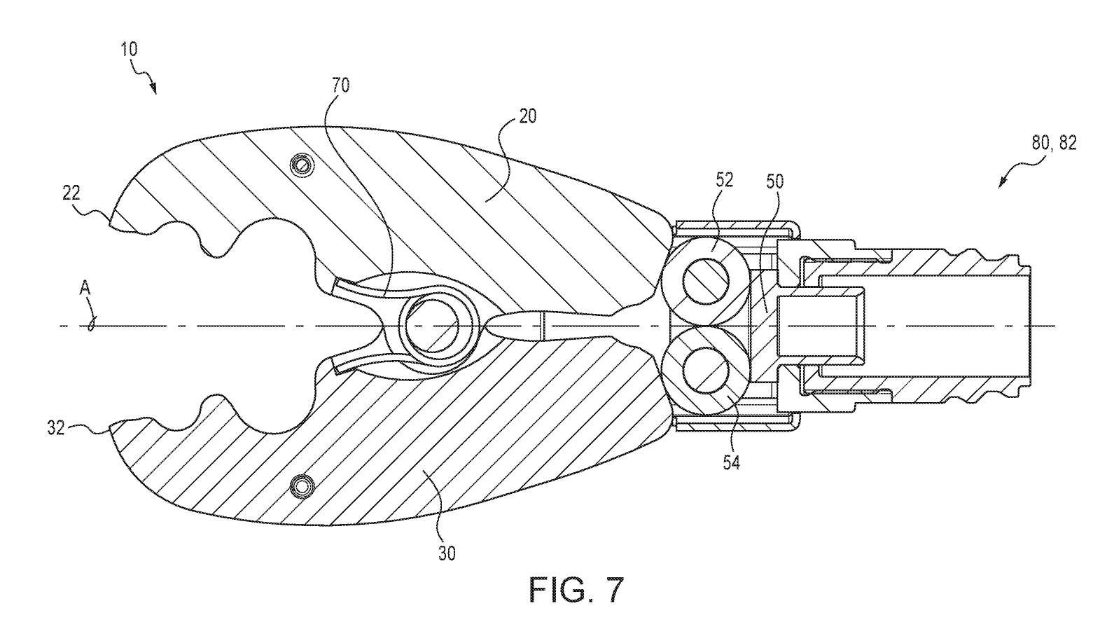

FIGS. 7 and 8 are cross sections of the tool head 10 taken along plane A-A in FIG. 6. FIG. 7 shows the tool head 10 in a state at which the jaws 20, 30 are fully opened. FIG. 8 shows the tool head 10 in a state at which the jaws 20, 30 are fully closed. FIGS. 7 and 8 also show a longitudinal axis A of the tool head 10. As shown, the axis A generally bisects the tool head 10.

In particular embodiments, each cam surface defined on a jaw, extends at a particular orientation relative to the longitudinal axis A of the tool head 10. Referring to FIG. 8, the cam surface 28 of the first jaw 20 generally extends at an angle X as measured from the axis A of the tool head 10. Similarly, the cam surface 38 of the second jaw 30 generally extends at an angle Y as measured from the axis A of the tool head 10. The angles X and Y are typically equal to each other. And, the angles X and Y are typically within a range of from 40° to 50°. In certain versions, the angles X and Y are each ______°. It will be understood that the cam surfaces 28 and 38 may not be linear or planar, and thus the respective angles X and Y may not be constant at all locations along a respective cam surface. However, the description herein of the cam angles X and Y having particular orientations refers to the average angular orientation along a respective cam surface.

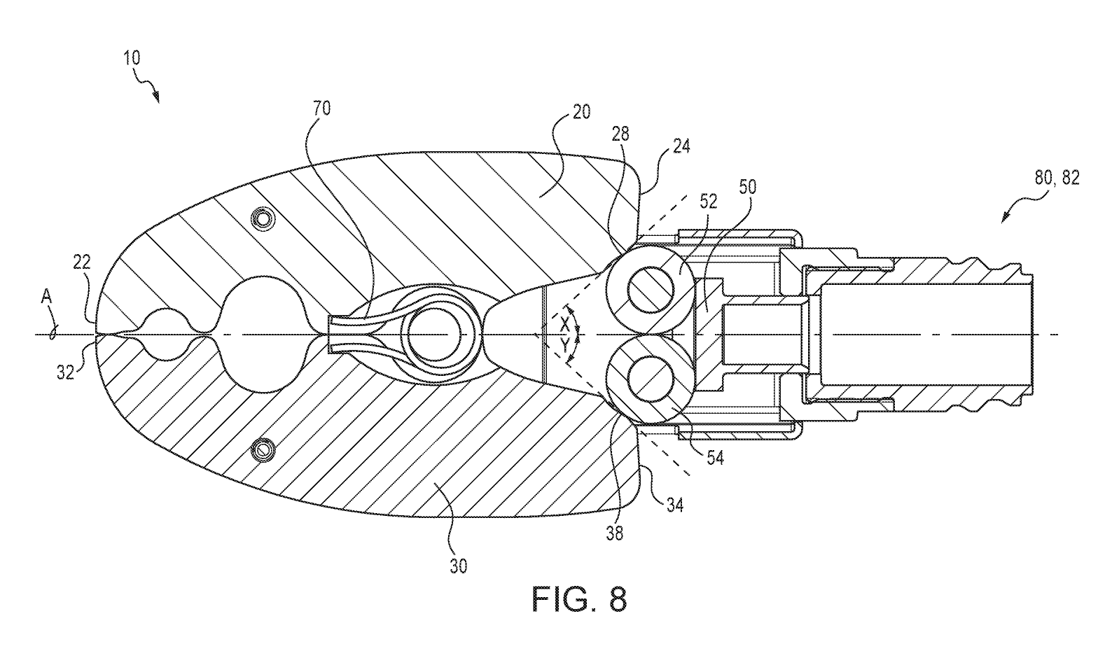

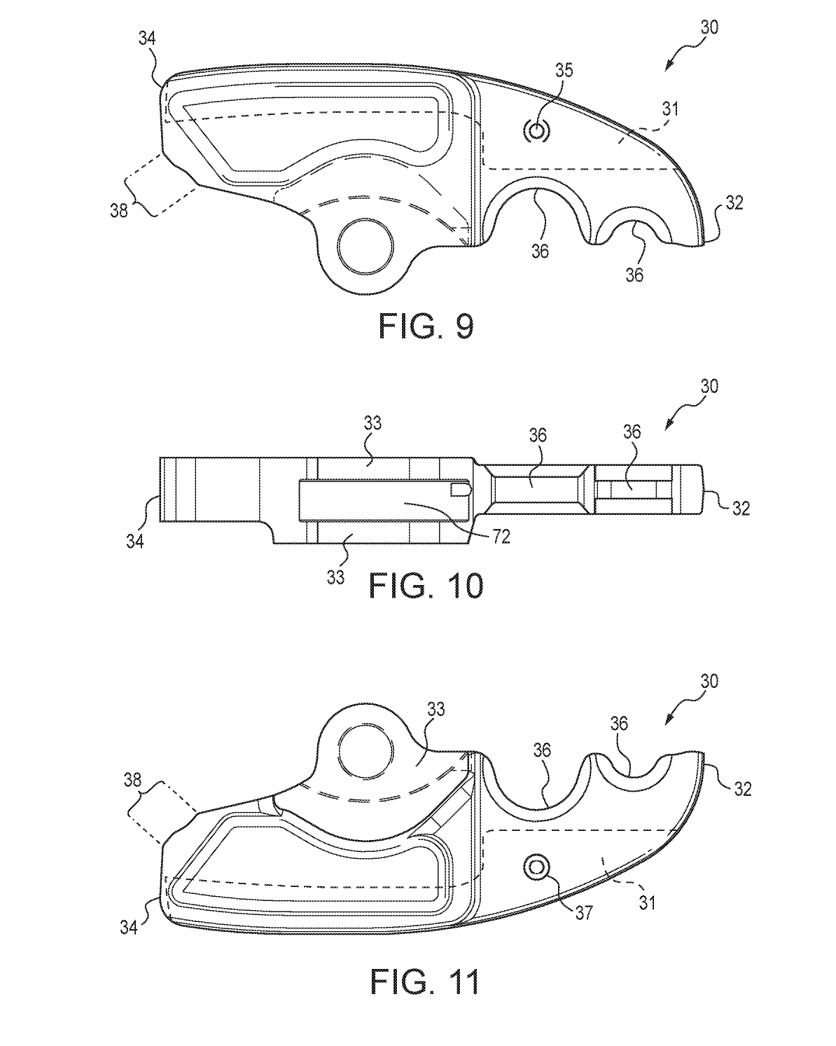

FIGS. 9-11 further illustrate a jaw such as the second jaw 30 and its various features and aspects. It will be appreciated that the present subject matter is not limited to the particular features and aspects described and illustrated herein. Instead, the tool heads of the present subject matter include a wide array of jaws and components.

### Quick Connect System

As noted, in many embodiments of the present subject matter, the tool head includes provisions for enabling the frame, the roller carriage, and the pair of jaws to be releasably engageable with a powered actuator. In certain embodiments, the releasable engagement provisions are in the form of collar configured for use with the Quick Connect System such as that described as quick release coupling 106 in US Patent Publication 2014/0260505. Additional details of the Quick Connect System are set forth in US Patent Publication 2012/0319398 and U.S. Pat. No. 9,242,422. Generally, the QCS collar which is provided on an engagement end of a tool head of the present subject matter includes at least two circumferential ridges separated by a circumferential recess. The ridges and recess are defined on the frame proximate an engagement end of the tool head. The ridge nearest the engagement end of the tool head has a height or maximum radial dimension that is less than that of the second adjacent ridge.

Generally, the Quick Connect System includes a locking ring, a cylindrical ball holding part and coupler, a spring element, and a plurality of spherical ball members retained within the ball holding part, all of which are provided on an engagement end of an actuator. The balls serve as movable locking bodies and are distributed around the periphery of the ball holding part. The locking ring is mounted on the ball holding part in an axially movable manner. The spring element is mounted in the assembly to urge the locking ring in an axial direction into a locking position when the tool head is engaged with an actuator. In order to unlock and disengage the tool head, and specifically a QCS collar of the tool head from the actuator, the locking ring is axially moved in an opposite direction.

### Actuators

As noted, the present subject matter tool heads are used by engaging the tool head with a powered actuator. In many applications, a hydraulic actuator is useful. A variety of hydraulic actuators can potentially be used in association with the tool heads to thereby provide a tool system. Generally, suitable actuators include an extendable ram that delivers a linear force that upon engagement with the tool head, imparts such force to the roller carriage of the tool head. The ram of the actuator is typically driven by a hydraulic circuit including a motor and pump that deliver hydraulic fluid to a chamber in communication with the ram. In many embodiments, the actuators are those that produce relatively high levels of force such as at least about 30 kN, more particularly at least 40 kN, and up to about 60 kN of linear extension force.

For embodiments of the tool head which include releasable engagement provisions in the form of a Quick Connect System, actuators such as those commercially available under the designation RE6 and RE60 from Ridge Tool Company can be used.

### Flexible Covers

The present subject matter also provides flexible covers that can be used in conjunction with the tool heads. The flexible covers are sized and shaped to fittingly enclose at least a portion of the outer surfaces of the pair of jaws. In many versions, the flexible covers fittingly enclose at least a majority of the outer surfaces of the pair of jaws. The flexible covers are configured to be removable from the tool heads. In many embodiments, the flexible covers are formed from relatively durable yet flexible polymeric materials such as polyethylene and polypropylene. However, it will be appreciated that the covers of the present subject matter can be formed from other materials. In particular embodiments, the flexible covers can be formed from electrically insulating materials. FIGS. 9 and 11 schematically illustrate a flexible cover 31 positioned on a portion of the jaw 30. A similar cover could also be provided in association with the other jaw 20.

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A tool head comprising:
a pair of pivotally attached jaws, each jaw defining a forward end, a rearward end, and a work surface, each jaw further defining a cam surface proximate the rearward end, the jaws positionable between a fully opened position and a fully closed position;
a roller carriage positionable between a fully extended position and a fully retracted position, the roller carriage including rollers positioned to contact the cam surface of each jaw upon positioning the roller carriage toward the fully extended position, thereby resulting in the jaws being positioned to the closed position;
a frame defining a forward end and a rearward end, the frame supporting and at least partially enclosing the pair of jaws and the roller carriage;
provisions for enabling the frame and the pair of jaws to be releasably engageable with a powered actuator;
a biasing member that urges (i) the pair of jaws to the fully opened position, and (ii) the roller carriage to the fully retracted position.

2. The tool head of claim 1 wherein the tool head is free of any biasing member directly engaging the roller carriage.

3. The tool head of claim 1 wherein the biasing member is a single biasing member.

4. The tool head of claim 1 wherein the pair of jaws include a pin about which the jaws pivot, and the biasing member is a torsion spring positioned about the pin.

5. The tool head of claim 1 wherein the tool head defines a longitudinal axis, and upon positioning the pair of jaws to the fully closed position, each cam surface defined on a jaw extends from the rearward end of the respective jaw toward the longitudinal axis at an angle within a range of from 40° to 50° as measured from the longitudinal axis.

6. The tool head of claim 1 further comprising:
a flexible cover adapted to fittingly enclose at least a portion of the outer surfaces of the pair of jaws.

7. The tool head of claim 1 wherein the provisions for enabling the frame and the pair of jaws to be releasably engageable with the powered actuator include at least two circumferential ridges separated by a circumferential recess defined on the frame.

8. The tool head of claim 7 wherein the at least two circumferential ridges include a first ridge disposed proximate an engagement end of the tool head and a second ridge disposed between the first ridge and the pair of jaws, the first ridge having a height less than that of the second ridge.

9. A tool head comprising:
a pair of pivotally attached jaws, each jaw defining a forward end, a rearward end, and a work surface, each jaw further defining a cam surface proximate the rearward end, the jaws positionable between a fully opened position and a fully closed position;
a roller carriage positionable between a fully extended position and a fully retracted position, the roller carriage including rollers positioned to contact the cam surface of each jaw upon positioning the roller carriage toward the fully extended position, thereby resulting in the jaws being positioned to the closed position;
a frame defining a forward end and a rearward end, the frame supporting the roller carriage and the pair of jaws;
the tool head defining a longitudinal axis, wherein upon positioning the pair of jaws to the fully closed position, each cam surface defined on a jaw extends from the rearward end of the respective jaw toward the longitudinal axis at an angle of from 40° to 50° as measured from the longitudinal axis.

10. The tool head of claim 9 further comprising:
provisions for enabling the frame and the pair of jaws to be releasably engaged with a powered actuator.

11. The tool head of claim 10 wherein the provisions for enabling the frame and the pair of jaws to be releasably engageable within the powered actuator include at least two circumferential ridges separated by a circumferential recess defined on the frame.

12. The tool head of claim 11 wherein the at least two circumferential ridges include a first ridge disposed proximate an engagement end of the tool head and a second ridge disposed between the first ridge and the pair of jaws, the first ridge having a height less than that of the second ridge.

13. The tool head of claim 9 further comprising:
a biasing member that urges the pair of jaws to the fully opened position.

14. The tool head of claim 13 wherein the biasing member also urges the roller carriage to the fully retracted position.

15. The tool head of claim 9 wherein the tool head is free of any biasing member directly engaging the roller carriage.

16. The tool head of claim 13 wherein the biasing member is a single biasing member.

17. The tool head of claim 13 wherein the biasing member is a torsion spring.

18. The tool head of claim 9 further comprising:
a flexible cover adapted to fittingly enclose at least a portion of the outer surfaces of the pair of jaws.

19. A tool system comprising:
a powered actuator; and
a tool head, the tool head including:
a pair of pivotally attached jaws, each jaw defining a forward end, a rearward end, and a work surface, each jaw further defining a cam surface proximate the rearward end, the jaws positionable between a fully opened position and a fully closed position;
a roller carriage positionable between a fully extended position and a fully retracted position, the roller carriage including rollers positioned to contact the cam surface of each jaw upon positioning the roller carriage toward the fully extended position, thereby resulting in the jaws being positioned to the closed position;
a frame defining a forward end and a rearward end, the frame supporting and at least partially enclosing the pair of jaws and the roller carriage;
provisions for enabling the frame and the pair of jaws to be releasably engageable with the powered actuator;
a biasing member that urges (i) the pair of jaws to the fully opened position, and (ii) the roller carriage to the fully retracted position.

20. The tool system of claim 19 wherein the actuator includes releasable engagement provisions along an engagement end of the actuator, the releasable engagement provisions including:
a cylindrical ball holding part and coupler;
a locking ring disposed on the ball holding part and axially positionable thereon between a locked position and an unlocked position;
a spring element biasing the locking ring toward the locked position;
a plurality of spherical ball members retained within the ball holding part.

21. The tool system of claim 19 wherein the tool head is free of any biasing member directly engaging the roller carriage.

22. The tool system of claim 19 wherein the biasing member of the tool head is a single biasing member.

23. The tool system of claim 19 wherein the pair of jaws of the tool head include a pin about which the jaws pivot, and the biasing member is a torsion spring positioned about the pin.

24. The tool system of claim 19 wherein the tool head defines a longitudinal axis, and upon positioning the pair of jaws to the fully closed position, each cam surface defined on a jaw extends from the rearward end of the respective jaw toward the longitudinal axis at an angle within a range of from 40° to 50° as measured from the longitudinal axis.

25. The tool system of claim 19 wherein the tool head further includes:
a flexible cover adapted to fittingly enclose at least a portion of the outer surfaces of the pair of jaws.

26. The tool system of claim 19 wherein the provisions of the tool head for enabling the frame and the pair of jaws to be releasably engageable with the powered actuator include at least two circumferential ridges separated by a circumferential recess defined on the frame.

27. The tool system of claim 26 wherein the at least two circumferential ridges include a first ridge disposed proximate an engagement end of the tool head and a second ridge disposed between the first ridge and the pair of jaws, the first ridge having a height less than that of the second ridge.

28. A tool system comprising:
a powered actuator; and
a tool head, the tool head including:
a pair of pivotally attached jaws, each jaw defining a forward end, a rearward end, and a work surface, each jaw further defining a cam surface proximate the rearward end, the jaws positionable between a fully opened position and a fully closed position;
a roller carriage positionable between a fully extended position and a fully retracted position, the roller carriage including rollers positioned to contact the cam surface of each jaw upon positioning the roller carriage toward the fully extended position, thereby resulting in the jaws being positioned to the closed position;
a frame defining a forward end and a rearward end, the frame supporting the roller carriage and the pair of jaws;
the tool head defining a longitudinal axis, wherein upon positioning the pair of jaws to the fully closed position, each cam surface defined on a jaw extends from the rearward end of the respective jaw toward the longitudinal axis at an angle of from 40° to 50° as measured from the longitudinal axis.

29. The tool system of claim 28 wherein the actuator includes releasable engagement provisions along an engagement end of the actuator, the releasable engagement provisions including:
a cylindrical ball holding part and coupler;
a locking ring disposed on the ball holding part and axially positionable thereon between a locked position and an unlocked position;
a spring element biasing the locking ring toward the locked position;
a plurality of spherical ball members retained within the ball holding part.

30. The tool system of claim 28 wherein the tool head further includes:
provisions for enabling the frame and the pair of jaws to be releasably engaged with a powered actuator.

31. The tool system of claim 30 wherein the provisions for enabling the frame and the pair of jaws to be releasably engageable within the powered actuator include at least two circumferential ridges separated by a circumferential recess defined on the frame.

32. The tool system of claim 31 wherein the at least two circumferential ridges include a first ridge disposed proximate an engagement end of the tool head and a second ridge disposed between the first ridge and the pair of jaws, the first ridge having a height less than that of the second ridge.

33. The tool system of claim 28 wherein the tool head further includes:
a biasing member that urges the pair of jaws to the fully opened position.

34. The tool system of claim 33 wherein the biasing member also urges the roller carriage to the fully retracted position.

35. The tool system of claim 28 wherein the tool head is free of any biasing member directly engaging the roller carriage.

36. The tool system of claim 33 wherein the biasing member is a single biasing member.

37. The tool system of claim 33 wherein the biasing member is a torsion spring.

38. The tool system of claim 28 wherein the tool head further includes:
a flexible cover adapted to fittingly enclose at least a portion of the outer surfaces of the pair of jaws.
